(19) United States
(12) Patent Application Publication
(10) Pub. No.: US 2023/0013299 A1
(43) Pub. Date: Jan. 19, 2023

(54) MOULD FOR THE MANUFACTURE OF CERAMIC PACKING MEMBERS

(71) Applicant: JEMMTEC LIMITED, Dewsbury (GB)

(72) Inventors: Mark STUCKEY, Dewsbury (GB); Justine STUCKEY, Dewsbury (GB)

(21) Appl. No.: 17/778,190

(22) PCT Filed: Nov. 19, 2020
(86) PCT No.: PCT/GB2020/052951

§ 371 Date: May 19, 2022

(30) Foreign Application Priority Data
Nov. 20, 2019 (GB) 1916890.5

(51) Int. Cl. B28B 7/00; B28B 7/34; B01J 19/30

(52) U.S. Cl. CPC B28B 7/0064; B28B 7/348; B28B 7/0002; B01J 19/30; B01J 2219/30416; B01J 2219/3183; B01J 2219/3186

(57) ABSTRACT

A mould for manufacturing a packing member from a liquid ceramic composition. The mould including a first part and a second part, wherein the first part and/or the second part comprise an open mould cavity and wherein the first and second parts are operable to engage to form a closed mould cavity, wherein the mould further includes a reservoir forming member, and wherein the mould is operable to be moved from an open position in which the first and second parts are at least partially spaced such that the reservoir member forms a reservoir cavity and the mould cavity is open, to a partially closed position in which the location of the reservoir cavity has moved with respect to the mould cavity and/or the volume of the reservoir cavity has reduced, and then to a closed position in which the first and second parts are engaged such that the mould cavity is closed.

### FIELD

The present invention relates to moulds for use in the manufacture of packing members for packed beds, in particular to supports for catalysts and to supported catalysts. More specifically, the present invention relates to moulds for use in the manufacture of ceramic catalyst supports and supported catalysts for use in processes such as the steam reforming and the production of direct-reduced iron.

### BACKGROUND

Metal catalysts used in industrial processes such as steam reforming and the production of direct-reduced iron are more active if finely divided into small particles to increase the metal surface area. A large metal surface area can be maintained during such reactions by spreading the metal particles across a refractory support. Another advantage of the use of catalyst supports in such processes is that only a small amount of the more expensive catalytic metals is required for dispersion onto a large amount of abundant inexpensive support materials, thereby considerably reducing the cost of catalytic materials required at commercial scale.

In many such processes the reaction requiring a catalyst is very fast and is limited to the pellet surface. The reaction will therefore depend on the geometric surface area of the supported catalyst. Additionally, a supported catalyst having low internal surface area (BET) and so small internal pore volume will generally suffer from lower activity in such processes. The strength of a support is also important as breakage during the loading, operation and discharge of the supported catalyst can reduce activity and increase delays and costs. For example, in the Midrex process for direct-reduced iron (DRI) the catalysts can be subject to high levels of mechanical handling and thermal cycling, as are steam reforming catalysts. Furthermore, the supported catalyst should provide good heat transfer characteristics while maintaining a low pressure drop.

Supports for catalysts in such industrial processes are typically made by extrusion, pelleting or granulation of ceramic powder followed by calcination of the green body.

However, it has been found that such methods can only offer restricted support geometry and physical properties. For example, such supports may achieve high strength, but only at the expense of low geometric surface area and poor porosity.

Therefore, there is a requirement for improved supports for catalysts having a better combination of desirable properties that are able to be produced economically. It is therefore an object of aspects of the present invention to address one or more of the abovementioned or other problems.

### SUMMARY

According to a first aspect of the present invention there is provided a mould for manufacturing a packing member from a liquid ceramic composition, the mould comprising a first part and a second part, wherein the first part and/or the second part comprise an open mould cavity and wherein the first and second parts are operable to engage to form a closed mould cavity, wherein the mould further comprises a reservoir forming member, and wherein the mould is operable to be moved from an open position in which the first and second parts are at least partially spaced such that the reservoir member forms a reservoir cavity and the mould cavity is open, to a partially closed position in which the location of the reservoir cavity has moved with respect to the mould cavity and/or the volume of the reservoir cavity has reduced, and then to a closed position in which the first and second parts are engaged such that the mould cavity is closed.

According to a second aspect of the present invention there is provided a process for producing a packing member for use in a packed bed comprising the steps of:
a. arranging a mould comprising a first part and a second part wherein the first part and/or the second part comprise an open mould cavity and wherein the mould further comprises a reservoir forming member, in an open position wherein the first and second parts are at least partially spaced such that the reservoir member forms a reservoir cavity and the mould cavity is open;
b. at least partially filling the reservoir cavity of the mould with a liquid ceramic com position;
c. moving the mould to a partially closed position such that the location of the reservoir cavity moves with respect to the mould cavity and/or the volume of the reservoir cavity reduces, to transfer a portion of the liquid ceramic composition from the reservoir cavity into the open mould cavity; and
d. moving the mould to a closed position wherein that the first and second parts are engaged to close the mould cavity such that a portion of the liquid ceramic composition is held within the closed mould cavity to produce a green body; and
e. optionally, heating the green body;
f. demoulding the green body; and
g. optionally, calcining the green body to produce a packing member.

According to a third aspect of the present invention, there is provided a moulding apparatus for use in the production of a packing member from a liquid ceramic composition, suitably a moulding apparatus for use in the process of the second aspect of the present invention, the moulding apparatus comprising a mould according to the first aspect of the present invention and a guiding member operable to arrange the mould in the open position.

According to a fourth aspect of the present invention, there is provided a packing member for use in a packed bed, preferably for use as a catalyst support in a packed bed reactor, obtainable by moulding a liquid ceramic composition in a mould according to the first aspect of the present invention, by a process according to a second aspect of the present invention and/or in a mould apparatus according to the third aspect of the present invention.

The first and second parts may each comprise an open mould cavity. Suitably, the mould cavity of the first and second parts may be open partial mould cavities and the first and second parts of the mould are operable to engage such that the partial mould cavity of the first part aligns with the partial mould cavity of the second part to form a closed enlarged mould cavity. “Open” mould cavity when used herein may mean that the packing member or green body, or part thereof, is operable to be removed from the mould cavity via the same aperture through which the liquid ceramic composition is introduced into the mould cavity. “Closed” mould cavity when used herein may mean that the liquid ceramic composition is held within the mould cavity such that it is not able to leave the mould cavity.

The first and/or the second parts may comprise a plurality of open mould cavities. Suitably, each of the first and/or second parts may comprise a plurality of open partial mould cavities.

The mould cavity may comprise texturing that is operable to produce surface structures on the packing member. Suitably, the face of the mould cavity that is operable to contact the liquid ceramic composition during moulding may comprise texturing.

The mould cavity may comprise a pin operable to form bore in the packing member, such as a bore extending through the packing member. Suitably the mould cavity may comprise at least two pins, such as at least three or at least four pins. The pin may be arranged on the bottom face of the mould cavity and extend upwardly toward the opening of the mould cavity. The pin may be arranged substantially centrally on the bottom face of the mould cavity. The pin may be cylindrical.

The reservoir member may be operable to form a reservoir cavity that can receive and hold a liquid ceramic composition. The reservoir cavity may not be a moulding cavity such that in the closed position the reservoir cavity is substantially not operable to hold a portion of the composition or form a moulded product.

The reservoir member may comprise a first reservoir member arranged on the first mould part and a second reservoir member arranged on the second mould part, wherein the first and second reservoir members are operable to cooperatively engage to form a reservoir cavity. Suitably, the first and second reservoir members may be male and female reservoir members, such that the male reservoir member is operable to be received into the female reservoir member to form a reservoir cavity. The male reservoir member may be in the form of a tongue and the female reservoir member may be in the form of a groove. Suitably, the male and female reservoir members may be operable to form a tight-fit when engaged. By “tight-fit” herein it is meant a fit that is operable to prevent the liquid ceramic composition from passing through the engaged reservoir members.

The first and/or second mould part may comprise reservoir members, suitably tongue or groove, extending along opposing sides of the mould cavity of the mould part, suitably longitudinally extending reservoir members. Suitably, the first and second mould parts may each comprise a mould cavity and the first reservoir member comprises tongues extending along opposing sides of the mould cavity of a mould part and the second reservoir member comprises grooves extending along opposing sides of the mould cavity of a mould part. The reservoir members of the mould parts may further comprise a base reservoir member extending between the side reservoir members. The base reservoir member may extend laterally along the mould part. The base member may be arranged below the mould cavity of the mould part. Suitably, the first reservoir member may comprise a base tongue extending between the opposing side tongues, and/or the second reservoir member comprises a base groove extending between the opposing side grooves. Such a reservoir member configuration may be in the form of a U-shape, wherein the side reservoir members extend longitudinally along the mould part and the base reservoir member extends laterally along the mould part between the side reservoir members. The base reservoir member may provide the bottom inner face, or base, of the reservoir cavity in use. The side reservoir members may provide the side faces of the reservoir cavity in use. The surface of the mould part extending between the side reservoir members, which may also contain the mould cavity may provide the front and rear faces of the reservoir cavity. Typically, the reservoir cavity comprises a mouth. The mouth may extend between the ends of the side reservoir members that are not connected to a base reservoir member. Suitably, the mouth of the reservoir cavity may extend laterally across the mould part, typically substantially parallel with the base reservoir member.

Suitably, the first and/or second mould part may comprise a plurality of mould cavities in a grouping. The side reservoir members may be arranged to extend along opposing sides of the grouping. The base member may be arranged to extend below the grouping.

The reservoir member of the mould part may be arranged on the same face as the mould cavity. The reservoir members of the mould parts may be arranged such that engagement of the reservoir members is operable to align partial mould cavities on the mould parts to form an enlarged mould cavity in the closed position.

As such, when the mould is in the open position the reservoir members may be operable to engage to form a reservoir cavity that is operable to receive a liquid ceramic composition through the mouth of the reservoir cavity and then hold the liquid ceramic composition in the reservoir cavity. Suitably, a mould cavity may be arranged within the initial reservoir cavity when the mould is in the open position. A mould cavity may also be arranged outside of the initial reservoir cavity when the mould is in the open position. As the mould is moved from the open position to the partially closed position and then the closed position the reservoir members of the mould part may be operable to further engage such that the reservoir cavity moves along the grouping of mould cavities to close the now filled mould cavities in the initial reservoir cavity and to transfer the remaining composition into the relocated reservoir cavity and into new mould cavities. This movement may continue until the reservoir members are fully engaged such that the mould cavities are closed, suitably by engagement between the mould parts over the mould cavities. Typically, the reservoir cavity has a smaller volume than the combined volume of the mould cavities of the mould.

The first and/or second mould part may be resiliently deformable. The mould may be operable to be moved from the open position in which the first and second parts are partially spaced by deforming a mould part, to the partially closed position by reducing the deformation of the mould part, and to the closed position by further reducing the deformation of the mould part.

Suitably the first and/or second mould part may be formed of a polymeric material, such as silicone. The silicone may be formed from a two-part silicone composition, comprising a silicone resin and a curing agent or catalyst.

The material forming the first and/or second mould part may have a shore hardness of at least 5, such as at least 10, or at least 15, such as at least 20. The material forming the first and/or second mould part may have a shore hardness of up to 40, such as up to 35 or up to 32, such as up to 30. The material forming the first and/or second mould part may have a shore hardness of from 5 to 40, such as from 10 to 35 or from 15 to 32, such as from 20 to 30. Advantageously, it has been found that a material having a shore hardness within the abovementioned ranges provides a mould that has the flexibility to allow for effective moulding according to the present invention whilst maintaining sufficient shape and rigidity. As described herein, shore hardness was measured using ASTM D2240 type A.

The material forming the first and/or second mould part may have a shrinkage rate of up to 1%, such as up to 0.5%, or up to 0.4%, such as up to 0.3%. Advantageously, it has been found that materials having a shrinkage rate within the abovementioned ranges provides a mould that has improved alignment between the mould parts. As described herein, shrinkage rate may refer to the amount of dimensional change, suitably over a period of 1 week, such as a period of 1 month or a period of 3 months.

The mould part may comprise retaining members operable to assist with maintaining the alignment of the mould parts. The mould parts may comprise a retaining member that is operable to assist with maintaining the alignment of the mould parts during dosing of the liquid ceramic composition into the mould. The dosing retaining member may be spaced from the reservoir cavity, e.g. not to provide an internal face of the reservoir cavity. Typically the dosing retaining member is not directly attached to the reservoir member. The dosing retaining member may comprise cooperating members arranged on the first and second mould parts. Suitably, the cooperating dosing retaining members may be male and female such that the male retaining member can be received into the female retaining member to assist with alignment of the mould parts. The male retaining member may be a tongue and the female alignment member may be a groove. The retaining member of the mould part may be arranged below the base of the reservoir cavity. The retaining member may extend laterally along the mould part, substantially parallel with the base of the reservoir cavity or base reservoir member. Advantageously, the use of a dosing retaining member allows for a larger initial reservoir cavity to be formed whilst retaining good alignment of the mould parts.

The mould part may comprise a post-dosing retaining member operable to assist with retaining alignment of the mould cavities after dosing of the liquid ceramic composition. The post-dosing retaining member may be arranged outside of the reservoir cavity, e.g. such as to not provide an internal face of the reservoir cavity. The post-dosing retaining member may comprise cooperating members arranged on the first and second mould parts. Suitably, the cooperating post-dosing retaining members may be male and female such that the male retaining member can be received into the female retaining member to assist with retaining alignment of the mould parts. The male retaining member may be a tongue and the female alignment member may be a groove. The post-dosing retaining member may be arranged laterally adjacent to the mould cavity or grouping of mould cavities. The retaining member may extend laterally along the mould part. The post-dosing retaining member may comprise a set of multiple retaining members arranged on each side of the mould cavity or mould cavity grouping, suitably laterally adjacent to the mould cavity or mould cavity grouping. The retaining member sets may each comprise at least two retaining members spaced longitudinally along the mould part, such as at least three retaining members. Advantageously, the use of a post-dosing retaining member allows for improved retention of alignment between the mould parts after dosing of the composition.

The mould part may comprise a recess arranged above the mould cavity, suitably above the mouth of the reservoir cavity. Typically the recess is elongated, and may extend substantially parallel with the base of the reservoir cavity or base reservoir member. The recess may be operable to receive any excess composition contained in the reservoir cavity when the mould parts reach the closed position.

The mould part may comprise a guide member. Suitably the guide member may extend outwardly from the mould part. The mould part may comprise guide members arranged on each of two opposing faces of the mould part, suitably on two opposed side faces of the mould part. The mould part may comprise at least three guide members on each of two opposing faces of the mould part, such as at least 4, at least 5 or at least 6 guide members. The face of the mould part may comprise guide members arranged toward opposing ends of the face and an intermediate guide member arranged between the end guide members.

The mould part may comprise a reinforcing member, suitably the reinforcing member may be more rigid than the body of the mould part. The reinforcing member may be arranged at least partially within the mould part body. The reinforcing member may substantially extend from one end of the mould part body to another end, such as to an opposing end. The reinforcing member may protrude from the mould part to provide a guiding member. Suitably the reinforcing member may protrude on opposing sides of the mould part to provide guide members on opposing sides of the mould part. As such, the guide member may be provided by a protruding reinforcing member.

The packing member may be formed from a cast moulding composition or slip, such as a clay or non-clay castable composition, liquid cement or gel-cast composition. As such, the liquid ceramic composition may be a gel-cast composition, suitably the composition may comprise a ceramic material, an organic binder component and optionally a pore forming component.

The organic binder component may be operable to be substantially removed from the packing member after moulding of the packing member, preferably with heat treatment, more preferably removed during calcination of the packing member.

The organic binder component may comprise a polymerisable component, suitably the polymerisable component may comprise a polymerisable monomer and a crosslinking member, wherein the binder component is operable to polymerise to form a (co)polymer.

The polymerisable monomer may comprise one or more type of ethylenically unsaturated monomers, such as an acrylic monomer or derivative thereof such as an acrylamide monomer, and/or a vinyl monomer, such as a monomer selected from one or more of methacrylamide (MAM), N-(hydroxymethyl)acrylamide (hMAM), hydroxyethyl acrylamide (hEAM) and/or N-vinyl-2-pyrrolidinone (NVP). Preferably, the polymerisable monomer comprises one or more acrylamide monomers, more preferably a monomer selected from one or more of methacrylamide (MAM), N-(hydroxymethyl)acrylamide (hMAM) and hydroxyethyl acrylamide (hEAM). Most preferably, the polymerisable monomer comprises MAM.

The crosslinking member may be selected from one or more of a diethylenically unsaturated monomer, such as a diacrylic monomer or derivative thereof such as a diacrylamide monomer, an acrylic salt and/or a polyethylene glycol substituted acrylic monomer. The crosslinking member may be selected from one or more of poly(ethylene glycol) dimethacrylate (PEGDMA), N,N′-methylenebis(acrylamide) (BIS), ammonium acrylate and PEG methylethylmethacrylate (PEGMEM), preferably one more of poly(ethylene glycol) dimethacrylate (PEGDMA), and N,N′-methylenebis(acrylamide) (BIS).

The organic binder component may be formed from 40 to 95 wt % of polymerisable monomer and from 60 to 5 wt % of crosslinking member, such as from 50 to 90 wt % of polymerisable monomer and from 50 to 10 wt % of crosslinking member, or from 55 to 85 wt % of polymerisable monomer and from 45 to 15 wt % of crosslinking member, or from 60 to 80 wt % of polymerisable monomer and from 40 to 20 wt % of crosslinking member, such as from 65 to 75 wt % of polymerisable monomer and from 35 to 25 wt % of crosslinking member.

The composition may further comprise a polymerisation accelerator, operable to accelerate the polymerisation of the binder component. The polymerisation accelerator may be any suitable accelerator. For example, the accelerator may be tetramethylethylenediamine (TEMED).

The composition may further comprise an initiator operable to initiate polymerisation of the binder component. The initiator may be any suitable initiator. The initiator may be a free radical initiator. For example, the initiator may be ammonium persulphate and/or potassium persulphate.

The pore forming material may be operable to be removed from the packing member after moulding of the packing member, preferably with heat treatment, more preferably during calcination of the packing member. The pore forming material may be selected from one or more of microbeads, starch, seeds and/or cellulose.

The pore forming material may have a particle size distribution wherein D₁₀ is from 5 to 100 μm, preferably from 10 to 75 μm, more preferably from 15 to 50 μm, most preferably from 20 to 40 μm. The D₅₀ of the pore forming material may be from 50 to 200 μm, preferably from 75 to 175 μm, more preferably from 90 to 160 μm, most preferably from 100 to 150 μm. The D₉₀ of the pore forming material may be from 120 to 300 μm, preferably from 150 to 270 μm, more preferably from 170 to 250 μm, most preferably from 185 to 235 μm.

The ceramic material may be a refractory ceramic material. The ceramic material may comprise aluminium oxide, aluminium silicate, magnesium aluminate, calcium aluminate, zirconia, silica, titanate, carbon and/or magnesium oxide.

The ceramic material may have a particle size distribution wherein D₁₀ is from 0.1 to 20 μm, preferably from 0.5 to 10 μm, more preferably from 1 to 5 μm, most preferably from 1.5 to 3 μm. The D₅₀ of the pore forming material may be from 0.5 to 30 μm, preferably from 1 to 25 μm, more preferably from 1.5 to 20 μm, most preferably from 2 to 15 μm. The D₉₀ of the pore forming material may be from 10 to 100 μm, preferably from 15 to 80 μm, more preferably from 20 to 70 μm, most preferably from 25 to 60 μm.

The ceramic material may be a ceramic powder. The ceramic powder may be ball milled or spray dried. Advantageously, it has been found that ball milled or spray dried ceramic powder provides easier casting behaviour.

The composition or packing member may comprise a promoter, operable to increase the reactivity of the main reaction, and/or decrease undesirable side reactions. The promoter may be selected from one or more of oxides of lanthanum, copper, magnesium, manganese, potassium, calcium, zirconium, barium, cerium, sodium, lithium, molybdenum, yttrium, cobalt, and chromium.

The composition may further comprise a carrier, such as aqueous carrier. Suitably the composition may be an aqueous ceramic slurry.

The composition may comprise further additives. For example, the composition may comprise a dispersant, such as a polymeric salt, for example a salt of a polyacrylic, preferably an ammonium salt of a polyacrylic. A suitable dispersant may be selected from one or more of Ecodis P90, Narlex LD42 and Dispex A40.

The composition may comprise from 0.1 to 10% of polymerisable monomer by dry weight of the composition, preferably from 0.5 to 8 wt %, more preferably from 1 to 6 wt %, such as from 1.5 to 5 wt %, most preferably from 2 to 4 wt %.

The composition may comprise from 0.1 to 10% of crosslinking member by dry weight of the composition, preferably from 0.5 to 8 wt %, more preferably from 0.75 to 6 wt %, such as from 1 to 5 wt %, most preferably from 1 to 4 wt %.

The composition may comprise from 50 to 95% of ceramic material by dry weight of the composition, preferably from 50 to 90 wt %, more preferably from 55 to 85 wt %, most preferably from 60 to 80 wt %. The packing member may comprise at least 75% of ceramic material by dry weight of the composition, preferably at least 85 wt %, more preferably at least 90 wt %, such as at least 95 wt %, most preferably at least 97 wt % ceramic material.

The composition may comprise from >0 to 40% of pore forming member by dry weight of the composition, preferably from 0.5 to 30 wt %, more preferably 2 to 25 wt %, such as from 3 to 20 wt %, most preferably from 4 to 15 wt %.

The composition may comprise from 0.1 to 5% of initiator by dry weight of the composition, preferably from 0.5 to 4 wt %, more preferably from 0.75 to 3.5 wt %, most preferably from 1 to 3 wt %.

The composition may comprise up to 5% of accelerator by dry weight of the composition, preferably up to 3 wt %, more preferably up to 2 wt %, most preferably up to 1.5 wt %.

The composition may comprise from 0.1 to 10% of dispersant by dry weight of the composition, preferably from 0.5 to 8 wt %, more preferably 0.75 to 6 wt %, most preferably from 1 to 5 wt %.

The composition may have a solids content of from 45 to 99% by total weight of the composition, such as from 50 to 95 wt %, preferably from 55 to 90 wt %, most preferably from 60 to 85 wt %.

The composition may be formed by combining a pre-formed aqueous binder component with a ceramic composition. Suitably the aqueous binder component may comprise a polymerisable monomer, a crosslinking member and water.

Prior to contacting the liquid ceramic composition with the mould, the composition may be contacted with an initiator and optionally a polymerisation accelerator.

The packing member of the present invention may be an inert packing member. As such, the inert packing member may be substantially free of catalytic material. Advantageously, the use of inert packing member according to the present invention in a catalyst bed provides improved heat transfer and gas flow turbulence which helps the reactive media further along the reactor to be at a suitable temperature for the desired reaction.

The packing member, or support, of the present invention may be a supported catalyst with the inclusion of catalytic material. The catalytic material may be operable to provide catalytic activity in the desired process to which the supported catalyst is applied.

The catalytic material may comprise a metal selected from one or more of a transition metal, suitably a transition metal oxide, and/or a noble metal, suitably an alloy thereof. The catalytic material may comprise a metal selected from one or more of iron, nickel, silver, gold, platinum, ruthenium, vanadium, molybdenum, and cobalt.

The composition may be mixed before arranging in the mould to form a homogeneous slurry, suitably before addition of initiator and the optional accelerator. The composition may be mixed after addition of the initiator and the optional accelerator to form a homogeneous slurry.

The mould is preferably a cast mould. The mould may be operable to form surface structures on the green body.

The green body produced by step (c) may be dried by baking the green body at ≥40° C., such as ≥50° C. or ≥55° C. or ≥60° C. Suitably, the green body may be baked for ≥10 hours, such as ≥15 hours or ≥20 hours, for example ≥24 hours.

The green body may be calcined at ≥1000° C., preferably ≥1200° C., more preferably ≥1400° C., most preferably ≥1500° C. Suitably, the green body may be fired until substantially all of the binder and pore forming component has been removed from the support or supported catalyst.

The packing member may be impregnated with catalytic material by dipping the packing member into a solution of the catalytic material. The dipped packing member may be dried after dipping.

Advantageously, the present invention enables the green support or supported catalyst body to be removed from the mould while it is in a form that is still relatively rubbery, allowing for easier handling. This leads to a lower scrap rate than other types of casting techniques.

The guiding member of the apparatus of the present invention may be operable to guide the mould into the open configuration, suitably by receiving guide members of the mould. Suitably, the guide member may comprise a portion that is operable to arrange the mould in a closed, or at least partially closed, position and a portion that is operable to arrange the mould in position in which the mould parts are at least partially spaced in an open position. The mould may be operable to move in the guide member from the closed portion of the guide member to the spacing portion of the guide member. Typically, the guide member is operable to arrange the mould in an open position in which a portion of the mould parts are abutting and a portion of the mould parts are spaced, suitably in a position in which a dosing-retaining member may be engaged while a mould cavity is open and reservoir cavity formed. The guide member may be operable to arrange the mould in a position in which a dosing-retaining member is engaged and/or portions of the mould parts are abutting while a mould cavity is open and reservoir cavity formed, wherein the open mould cavity and/or reservoir cavity is arranged above the engaged dosing-retaining member and/or abutting portions of the mould parts. The guiding member may further comprise a driving member operable to move the mould through the guiding portion of the guiding member.

The moulding apparatus may further comprise a dosing member operable to dispense a liquid ceramic composition into the mould. Suitably the dosing member may be arranged above the guide portion of the guiding member.

The packing member may be a catalyst support, suitably a ceramic catalyst support. The packing member may be a supported catalyst.

The packing member of the present invention may be a cast packing member, such as a gel-cast packing member.

The packing member may have a geometric surface area per volume (GSA) of ≥0.7 cm²/cm³ and a side crush strength of ≥250 kgf; such as a GSA of ≥1 cm²/cm³, preferably a GSA of ≥1.2 cm²/cm³, more preferably a GSA of ≥1.3 cm²/cm³, most preferably a GSA of ≥1.4 cm²/cm³. The packing member may have a side crush strength of ≥275 kgf, preferably ≥300 kgf, more preferably ≥325 kgf, most preferably ≥350 kgf.

The packing member may have a GSA of ≥1.5 cm²/cm³ and a side crush strength of ≥150 kgf; such as a GSA of ≥1.7 cm²/cm³, preferably a GSA of ≥1.9 cm²/cm³, more preferably a GSA of ≥2.1 cm²/cm³, most preferably a GSA of ≥2.3 cm²/cm³. The packing member may have a side crush strength of ≥170 kgf, preferably ≥185 kgf, more preferably ≥200 kgf, most preferably ≥215 kgf.

The packing member may have a GSA of ≥3 cm²/cm³ and a side crush strength of ≥60 kgf, such as a GSA of ≥3.3 cm²/cm³, preferably a GSA of ≥3.6 cm²/cm³, more preferably a GSA of ≥3.9 cm²/cm³, most preferably a GSA of ≥4.2 cm²/cm³. The packing member may have a side crush strength of ≥70 kgf, preferably ≥80 kgf, more preferably ≥90 kgf, most preferably ≥100 kgf.

GSA herein is calculated by measuring the external dimensions of the packing member, including all macrostructure and surface structure features and calculating the surface area. The calculated surface area is then divided by the calculated volume of the packing member. Suitable 3D modelling software can be used to provide these calculations quickly and accurately.

Side crush strength herein is represented by a value given in kgf. This is the maximum load recorded at the point of failure of the sample when pressed & crushed between two parallel, flat, hardened steel plates of minimum diameter 80 mm. One plate is fixed to a load cell & recording device, and the other is attached to a ram which moves at a controlled rate of 5 mm/minute. Initial trial tests are carried out to determine the dimension in which the packing member is weakest. The side crush test is then carried out in the weakest direction.

The packing member may have a porosity of ≥6% preferably ≥15%, more preferably ≥20%, most preferably ≥25%. The packing member may have a porosity of from 6 to 50%, preferably from 15 to 40%, more preferably from 20 to 35%, most preferably from 25 to 30%. Suitably, the support may have a porosity of ≥15%, more preferably ≥20%, most preferably ≥25%. The support may have a porosity of from 15 to 50%, more preferably from 20 to 40%, most preferably from 25 to 35%.

Porosity herein is measured by mercury intrusion porosimetry, using ASTM D4284-12(2017)e1, Standard Test Method for Determining Pore Volume Distribution of Catalysts and Catalyst Carriers by Mercury Intrusion Porosimetry.

[76] The packing member may have a macrostructure and surface structures on the outer face of the macrostructure. Typically, the surface structures of the packing member are formed during the moulding step of the packing member, i.e. the step in which the green body of the packing member is formed, suitably by appropriate texturing in the mould cavity. As such, preferably the surface structures are not post-fabricated after the moulding of the green body of the packing member.

The macrostructure may be in the form of a multi-lobe, for example a trilobe, quadralobe or pentalobe; a ring; a sphere; a cube; a cuboid; a cylinder; or a cog.

The cog macrostructure comprises a plurality of castellations extending radially outwards. A cog macrostructure may have lateral cross-sections that include substantially circular, triangular, square or rectangular etc when excluding the castellations. At least some, and preferably all, of the castellations may be tapered along the depth and/or the width of the castellation, preferably each castellation is tapered in the same direction as the other castellations of the cog, suitably the widest and deepest points of the castellation may be toward the same end of the castellation.

The macrostructure may have a depressed upper and/or lower face, suitably at least 30% of the upper and/or lower face is depressed, such as at least 40% or at least 50%. It will be appreciated that a bore extending through the macrostructure is not a depression in the upper and/or lower face according to the present invention.

Advantageously, a cog macrostructure having tapered castellations and/or depressed upper or lower face has been found to provide improved packing density in combination with reduced interlocking.

A spherical macrostructure may comprise at least one linear trough on the outer face of the macrostructure, such as at least two, at least three or at least four linear troughs. Preferably, a spherical macrostructure comprises at least two linear parallel troughs, such as at least three or at least four. Preferably, the troughs are substantially hemispherical in a lateral cross-section.

The macrostructure may be a monolith or comprise one or more bores extending through the macrostructure. Preferably, the packing member comprises at least one bore extending through the macrostructure, more preferably, the macrostructure comprises at least three bores. The macrostructure may be a honeycomb structure. The bores of the macrostructure may be straight cut or faceted.

The packing member may comprise a plurality of surface structures, suitably a plurality of repeating surface structures. Preferably, the packing member comprises at least 5 surface structures, suitably repeating surface structure moieties, more preferably at least 10, such as at least 15, or at least 20, most preferably at least 25.

By surface structures it is meant raised and/or depressed portions on the support the height of which are significantly smaller than the width/diameter of the macrostructure of the packing member. Such surface structures may be considered to be surface texturing over the macrostructure of the packing member. The surface structures may be considered to not include microscopic surface roughness. For example, the packing member may be of cuboidal macrostructure having a width of 32 mm and a length of 50 mm. The outer face of this packing member may comprise a plurality of surface structures in the form of a plurality of repeating identical discrete mounds wherein each mound has a height of 2 mm. It will be appreciated that normal features of a macrostructure such as the plurality of castellations of a cog or the lobes of multilobe are not considered to be surface structures according to the present invention.

The surface structures may be in the form of ridges and/or mounds.

The ridges may be in the form of annular ridges, wherein said annular ridges are not restricted to a circular shape. The annular ridges may be in the form of a substantially circular shape or a regular convex polygen, such as a triangle, square, pentagon, hexagon, heptagon, octagon, nonagon, or decagon. Preferably the annular ridges are in the form of a regular convex polygen, more preferably pentagon, hexagon or heptagon, most preferably hexagon. The portion of the surface structure extending between the annular ridges may be flat, sloped and/or curved. For example, the portion of the surface structure extending between the annular ridges may be in the form of an inverted pyramid. The surface structures may comprise a plurality of attached annular ridge structures, suitably interconnected annular ridge structures such that a ridge of at least a first annular surface structure forms part of a second annular surface structure.

The surface structures in the form of mounds may be depressed into the macrostructure or project outwardly from the macrostructure. The mounds may be curved, pyramidal and/or stepped mounds. A stepped mound may comprise between 2 to 10 steps, such as between 3 and 8 steps. The mounds may interconnect such that adjacent mounds abut or are merged together.

The mean average height of the surface structures of the packing member may be up to 10 mm, preferably up to 7 mm, more preferably up to 6 mm, most preferably up to 5 mm.

The mean average height of the surface structures of the packing member may be at least 0.1 mm, such as at least 0.3 mm, preferably at least 0.5 mm, more preferably at least 0.7 mm, most preferably at least 0.8 mm. The height of the surface structures herein is measured using callipers with a depth measurement function.

The packing member may have a largest dimension of up to 1000 mm, such as up to 750 mm or up to 500 mm, preferably up to 400 mm. The packing member may comprise a width/diameter of up to 500 mm, such as up to 300 mm, or up to 200 mm, preferably up to 150 mm, more preferably up to 100m, most preferably up to 50 mm.

The mean average height the surface structures of the packing member may be up to 40% of the width/diameter of the packing member, such as up to 30%, preferably up to 25%, more preferably up to 20% and most preferably up to 15%.

The surface structures may extend over at least two faces of the packing member, such as at least a side face and a top face and/or bottom face.

The surface structures may extend over at least 50% of the side face of the packing member, such as at least 60%, preferably at least 70%, more preferably at least 80% and most preferably at least 85%. The surface structures may extend over at least 50% of the outer face of the packing member, such as at least 60%, preferably at least 70%, more preferably at least 80% and most preferably at least 85%. Where the surface structures include a repeating series of ridges, such as annular ridges, the surface extending between the ridges is included as part of the surface structure for this calculation even when that surface is substantially flat or where the ridges are not interconnected.

Advantageously, the mould and process of the present invention allows for the commercially viable production of packing members that have improved geometric surface area whilst still providing excellent strength. Further, the strength and/or porosity of the packing members that can be effectively produced using the present invention may be modified whilst keeping the same shape and thereby reducing redesign requirements and cost. Furthermore, the packing members may provide for highly porous supports whilst still providing excellent strength. Most advantageously, the packing member may provide improved geometric surface area in combination with excellent strength and high levels of porosity. The improved geometric surface area of the packing member is particularly advantageous for applications in which the catalytic reaction is surface based.

The packing member can also provide a high heat transfer co-efficient in combination with other improved properties, such as improved packing.

The packing member may also be used to provide excellent packing characteristics with low pressure drop. The packing member may provide improved packing density whilst maintaining optimum gas flow.

According to a fifth aspect of the present invention there is provided a method for producing a mould according to any of the first to third aspects of the present invention, the method comprising the steps of:
a. optionally, producing a digital model of a negative of the mould;
b. producing a negative mould according to the model using additive manufacturing, preferably printing with a 3D printer; and
c. forming the mould from the negative mould.

According to a sixth aspect of the present invention there is provided a method for producing a packing member, such as a support for a catalyst, or supported catalyst, the packing member may be a packing member according to the fourth aspect of the present invention, the method comprising the steps of:
a. optionally, producing a digital model of a negative of a mould according to any of the first to third aspects of the present invention;
b. producing a negative mould according to the model using additive manufacturing, preferably printing with a 3D printer;
c. forming a mould from the negative mould;
d. cast moulding a moulding composition, suitably the moulding composition may be a moulding composition as defined in relation to the fourth aspect of the present invention, to form a packing member or supported catalyst; suitably according to the process of the second aspect of the present invention.

According to a seventh aspect of the present invention there is provided a reactor comprising a catalyst bed wherein the catalyst bed comprises a packing member according to the fourth aspect of the present invention.

According to an eighth aspect of the present invention there is provided a reaction medium comprising a catalyst bed wherein the catalyst bed comprises a packing member according to the fourth aspect of the present invention.

Suitably, the reactor or reaction medium may be for the production of synthesis gas, such as ammonia, methanol, hydrogen, hydrogen peroxide and/or oxoalcohols; direct reduction of iron (DRI); endothermic gas generation; catalytic partial oxidation; or autothermal reforming.

According to a ninth aspect of the present invention there is provided the use of a packing member according to the fourth aspect of the present invention as a catalyst support.

According to a tenth aspect of the present invention, there is provided a method for the production of a synthesis gas, such as ammonia, methanol, hydrogen, hydrogen peroxide and/or oxoalcohols comprising the use of a reactor comprising a catalyst bed wherein the catalyst bed comprises a packing member according to the fourth aspect of the present invention to produce the synthesis gas.

According to an eleventh aspect of the present invention, there is provided a method for the production of direct reduced iron comprising the use of a reactor comprising a catalyst bed wherein the catalyst bed comprises a packing member according to the fourth aspect of the present invention.

According to a twelfth aspect of the present invention, there is provided a method for endothermic gas generation comprising the use of a reactor comprising a catalyst bed wherein the catalyst bed comprises a packing member according to the fourth aspect of the present invention.

According to a thirteenth aspect of the present invention, there is provided a method for catalytic partial oxidation comprising the use of a reactor comprising a catalyst bed wherein the catalyst bed comprises a packing member according to the fourth aspect of the present invention.

According to a fourteenth aspect of the present invention, there is provided a method for autothermal reforming comprising the use of a reactor comprising a catalyst bed wherein the catalyst bed comprises a packing member according to the fourth aspect of the present invention.

Any numerical range recited herein is intended to include all sub-ranges subsumed therein. Singular encompasses plural and vice versa. For example, although reference is made herein to “a” first part and “a” second part, “an” open mould cavity, “a” reservoir forming member, and the like, one or more of each of these and any other components can be used. As used herein, the term “polymer” refers to oligomers and both homopolymers and copolymers, and the prefix “poly” refers to two or more.

The use of “mould” herein is intended to refer to a container having a hollow portion that is used to give shape to a liquid composition upon hardening to a solid form. The mould may be a cast, a die or a former, for example.

The use of “longitudinal” and “lateral” herein is in relation to the reservoir cavity such that longitudinal refers to an axis extending substantially through the mouth and the base of the cavity and “lateral” refers to an axis extending substantially perpendicular to the longitudinal axis.

All of the features contained herein may be combined with any of the above aspects in any combination.

For a better understanding of the invention, and to show how embodiments of the same may be carried into effect, reference will now be made, by way of example, to the following figures.

### BRIEF DESCRIPTION OF DRAWINGS

The invention will now be described by way of example only and with reference to the accompanying drawings, in which:

FIG. 1 shows a top perspective view of a first embodiment of a mould according to the present invention.

FIGS. 2A and 2B show a top view of a second embodiment of a mould according to the present invention.

FIG. 3A shows a top perspective view of a first embodiment of a mould apparatus which is formed of the mould according to the second embodiment in an open position.

FIG. 3B shows a top view of the mould apparatus of FIG. 3A.

FIG. 4A shows a top perspective view of the mould apparatus of FIG. 3A with the mould in a partially closed position.

FIG. 4B shows a top view of the mould apparatus of FIG. 4A.

FIG. 5 shows a perspective view of a packing member according to the present invention.

### DESCRIPTION OF EMBODIMENTS

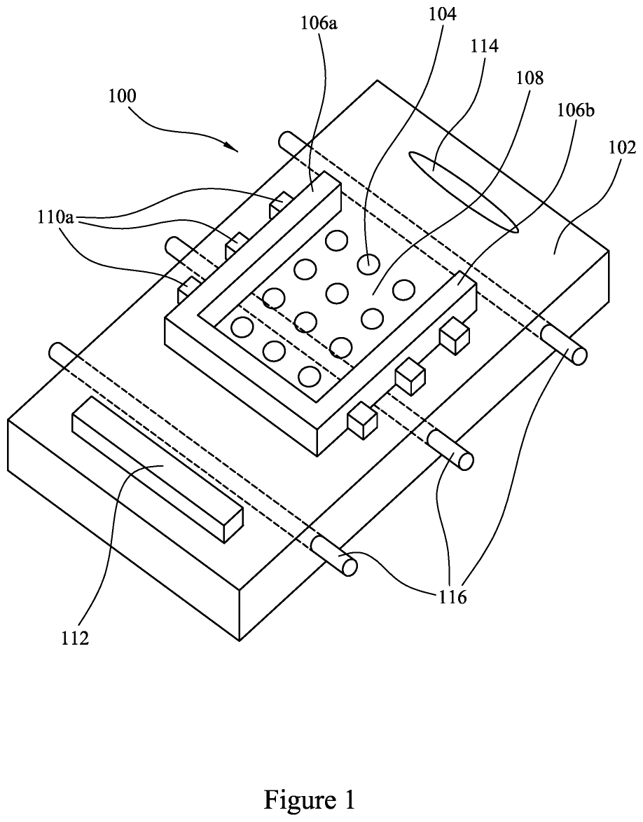

FIG. 1 shows a mould 10 according to a first embodiment of the invention. Mould 10 is substantially cuboidal and is formed of a first mould part 100 and a second mould part 200. First part 100 and second part 200 each contain about half of the mass of mould and each are formed of a resiliently deformable two-part silicone-based rubber.

First mould part 100 is formed of substantially cuboidal body 102. Body 102 has a rectangular inner face and a rectangular outer face. The inner face forms an inside face of the mould and the outside face forms an outside face of the mould when the mould parts are engaged. Body 102 also has a rectangular front face, rear face, and two side faces.

The inner face of body 102 has a grouping of twelve discrete generally hemispherical partial mould cavities 104 that contain surface texturing on the moulding surfaces of the cavities. The mould cavities are arranged in a grouping of four rows with three cavities 104 per row. The partial cavities 104 are spaced equidistantly from adjacent mould cavities to form a grid-like grouping arrangement located laterally centrally on the inner face. The first row is located proximal to, and parallel with, but spaced from, the edge of the inner face that is adjacent to the front face of the body 102 and the last (fourth) row is located proximal to, and parallel with, but spaced from the edge of the inner face that is adjacent to the rear face. The first row is closer to its abovementioned edge than the last row is to its respective abovementioned edge. Extending along either side of the grid-like grouping of partial cavities 104 protrudes side reservoir member tongues 106a and 106b. Side reservoir member tongues 106a, 106b are generally cuboidal shaped with a convex upper face and which extend longitudinally along the inner face from the edge that is adjacent to the front face to just after the last row of partial cavities 104. Side reservoir members 106a, 106b are connected at the bottom end (i.e. the end proximal to the rear face of body 102) via base reservoir member tongue 106c. Base reservoir member 106c is the same height as side reservoir members 106a and 106b and it extends laterally across the inner face to connect reservoir members 106a and 106b. Reservoir members 106a, 106b are integrally connected at each end of base reservoir member 106c to form a generally U-shaped enclosure that surrounds the grid-like grouping of partial cavities 104 on both sides and at the bottom (i.e. the end proximal to the rear face of body 102). This enclosure forms part of a reservoir cavity 108, in which the partial cavities 104 are located. The reservoir cavity has a laterally extending mouth in the form of an open end that extends between the ends of the side reservoir members that are not connected to the base reservoir member. As such, the mouth is arranged between the first row of partial cavities and the edge of the inner face that is adjacent to the front face of the body 102.

Mould part 100 further has two sets of three post-dosing cube-shaped retaining members 110a,b that is integrally formed on two sides with the inner face and the side reservoir members. Each of the post-dosing retaining members extends outwardly from the inner face and side reservoir members. The first set of retaining members 110a is arranged along the outer side face of side reservoir member 106a (relative to the reservoir cavity), and the second set of retaining members 110b is arranged opposite to the first set on the outer side face of side reservoir member 106b. The three retaining members of each of sets 110a and b are equidistantly spaced longitudinally down the inner face from the adjacent retaining member of the set and each retaining member is directly opposite a corresponding retaining member on the opposite side reservoir member.

Inner face of body 102 is formed of dosing retaining tongue member 112 spaced from, located below, and extending parallel with, base reservoir member 106c, and proximal to, and extending parallel with, but spaced from, the edge of the inner face that is adjacent to the rear face. Dosing retaining member 112 is a generally cuboidal protrusion and extends laterally across body 102 and is spaced from the side edges.

An elongate recess 114 is located on the inner face between the mouth of the reservoir cavity 108 and proximal to, but spaced from, the edge of the inner face that is adjacent to the front face of the body 102. Recess 114 is positioned relatively laterally centrally on the inner face between, and spaced from, the side edges of body 102. Recess 114 is generally oval shaped. Recess 114 is generally coterminous with the width of the mouth of the reservoir cavity.

First mould part 100 also has three cylindrical spaced reinforcing rods 116 which extend laterally through the centre mass of body 102 from one side face to the other side face at three different points along body 102. Rods 116 protrude out from the side faces on both sides so that there are three protrusions on either side of the first mould part 100 to act as guide members. Rods 116 are spaced equidistantly along the longitudinal length of body 102.

Second mould part 200 (not shown) is the same as first mould part 100 but has inwardly extending female equivalents of the reservoir members and retaining members. As such, second mould part 200 has corresponding female reservoir members 206 (not shown) which are cuboidal grooves within the body 202 (not shown) suitable for receiving the reservoir members of the first mould part 100, and also female retaining members 210 (not shown) and 212 (not shown) which allow the male retaining members 110, 112 to fit within so that they are engaged, and hold the first and second mould parts 100, 200 in alignment. When the first mould cavity 100 and second mould cavity 200 are engaged together the partial cavities 104, 204 form closed enlarged generally spherical mould cavities 304 (not shown).

In use, mould 10 is arranged in an open position wherein the first mould part 100 and second mould part 200 are partially spaced so that the dosing retaining members 112, 212 are cooperatively engaged to hold the first and second mould parts 100, 200 in alignment and so that reservoir members 106, 206 (not shown) are sufficiently engaged such as to form a reservoir cavity in which the base reservoir member forms the base of the cavity and all of the mould cavities are open. In this configuration, the front faces of the mould parts are spaced and the rear faces of the mould parts are not.

In this initial a configuration, the initial reservoir cavity 108 can be filled with a liquid ceramic composition. This is done by dropping the liquid composition from above the spaced front faces of the mould parts into the mouth of the reservoir cavity 108. The liquid composition received will be held in cavity 108 and will also enter and fill the mould cavities 104, 204 that are within the initial reservoir cavity.

Mould 10 can then be then moved to a partially closed position by further engaging the side reservoir members 106, 206 in a graduated manner from the base reservoir member upwards toward the mouth of the reservoir cavity. This action results in the closure of the initial reservoir cavity, which closes some of the now filled mould cavities, but by further engaging the side reservoir members the reservoir cavity is moved further up mould 10 towards the front faces of the mould parts. The relocated reservoir cavity carries any remaining composition that was not taken up by the initially filled mould cavities. This has the effect of transferring a portion of the liquid ceramic composition higher up the grouping of cavity members to thereby allow for the composition to move from the relocated reservoir cavity 108 into the previously empty open mould cavities that now fall within the relocated reservoir cavity 108.

The mould parts 100, 200 can then be moved to a closed position in which the reservoir members 106, 206, and post-dosing retaining members are fully engaged, thereby closing the reservoir cavity and also closing all of the mould cavities so that the liquid ceramic composition is held within the closed mould cavities 304. Any excess composition is captured in recess 114.

The composition is held within the mould cavities 304 until a green body is produced; optionally, with heating of the green body.

The green body can then be de-moulded and the green body calcined to produce a packing member.

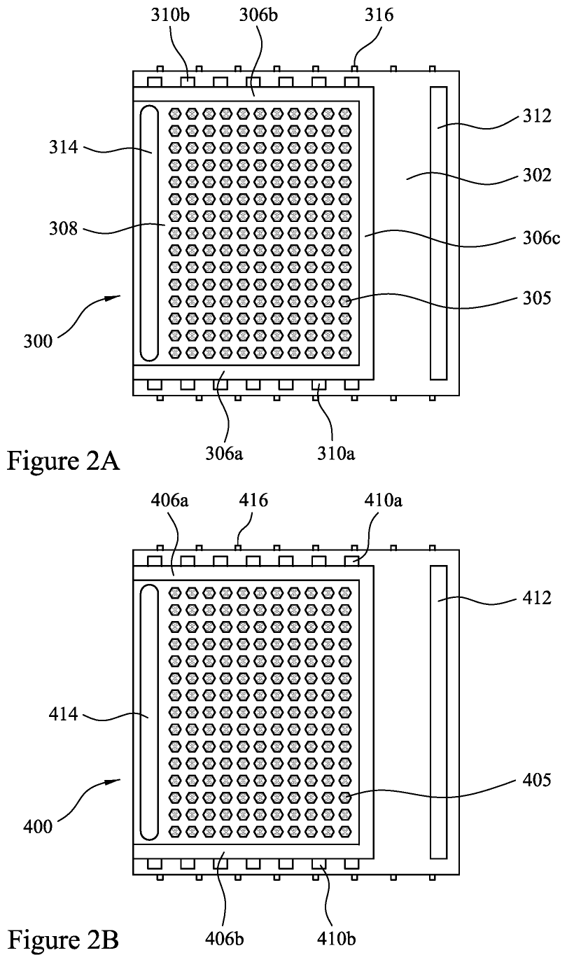

FIGS. 2A and 2B show a second embodiment of a mould 20 according to the present invention. Mould 20 is substantially cuboidal and has a first mould part 300 and a second mould part 400, as shown in FIGS. 2A and 2B. First mould part 300 and second mould part 400 are largely structurally the same as the first mould part 100 and second mould part 200 of the first embodiment. Mould 20 has all of the features as described in the first embodiment, unless stated otherwise below.

First and second mould parts 300 and 400 comprise a larger number of partial cavities, 305 and 405 respectively. There are eleven linear co-terminal and parallel rows of partial cavities 305, 405 with 15 cavities per row.

Side reservoir member tongues 306a and 306b are located on first mould part 300 and extend longitudinally along the inner face from just after the last row of partial cavities 305 to the edge of the inner face that is adjacent to the front face of the body 302. Side reservoir member tongues 306a and 306b, as well as base reservoir member tongue 306c, thereby enclose the partial cavities 305 and the elongate recess 314 located on the inner face of body 302. Side reservoir members 406a and 406b are located in the same way on second mould part 400.

The number of post-dosing cube-shaped retaining members 310a,b that are integrally formed on two sides with the inner face and the side reservoir members 306a,b has increased to seven on each side compared to the first embodiment. There are also seven corresponding female retaining members 410a,b on the second mould part 400. There are eight evenly spaced reinforcing rods 316 which extend laterally through the centre mass of each of the mould parts in the same way as in the first embodiment.

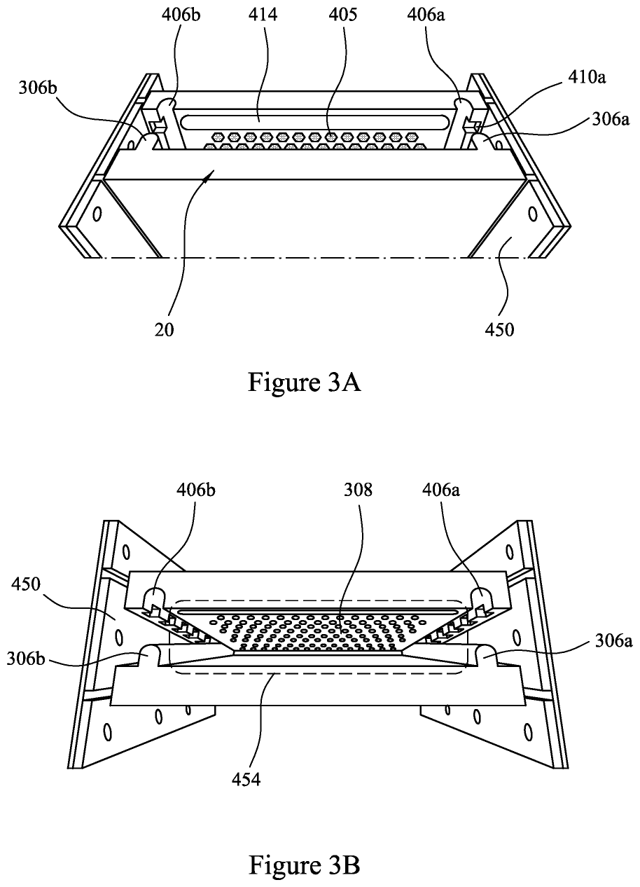

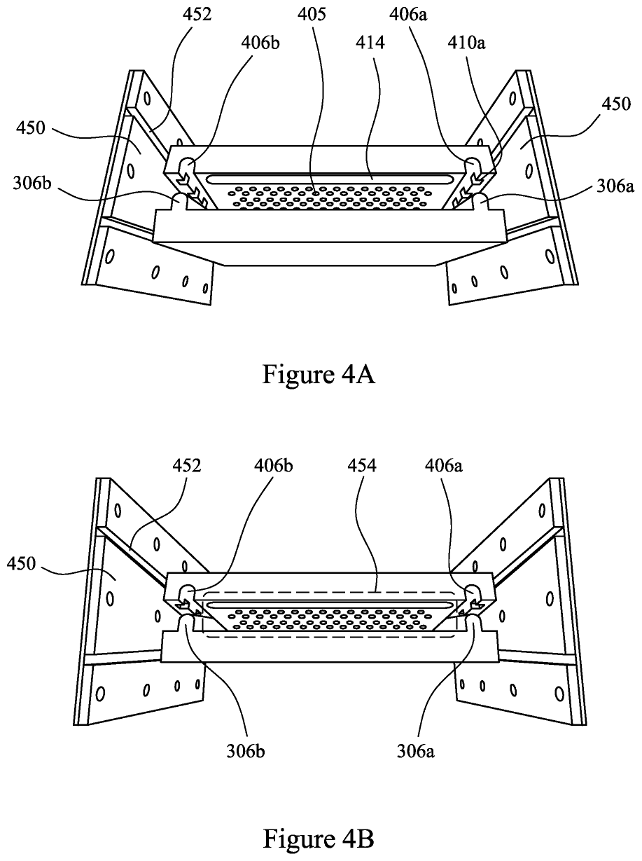

FIGS. 3 and 4 show a first embodiment of a mould apparatus 30 according to the present invention. The mould apparatus 30 is formed of a mould 20 according to the above described second embodiment and two guiding members 450. Guiding members 450 are fixed in a vertical orientation. Each guiding member 450 has two cuboidal shaped grooves 452 running longitudinally down the guide member at a slight diagonal so that the distance between the two grooves 452 is smaller at the bottom of the guiding member 450 than at the top of guiding member 450. The grooves of each guide member are arranged to face toward and directly oppose a corresponding groove of the other guide member.

Reinforcing rods 316, 416 can fit into grooves 452 on the respective sides of the mould parts to allow the mould 20 to travel along the grooves and to be held vertically so that the front face of mould parts 300 and 400 are pointing upwards and the rear face is pointing downwards.

In use, mould 20 is arranged in an open position by rods 316 and 416 entering grooves 452 at the bottom of the guide member and moving the mould up the guiding member 450 until the front faces of mould parts 300 and 400 are toward the top of guiding member 450 (FIG. 3A). As mould parts 300 and 400 are moved up the guiding member 450 the mould parts 300 and 400 become spaced at the upper end due to the grooves 452 being outwardly slanted, to give an open position in which an initial reservoir cavity is formed in the space between the mould parts. In this position the dosing retaining members 312, 412 are cooperatively engaged at the lower end of the mould to hold the first and second mould parts 300, 400 in alignment and to allow for a large reservoir cavity to be formed in which the base reservoir member forms the base of the cavity and all of the mould cavities are open.

In the open position, the initial reservoir cavity 308 can receive a liquid ceramic moulding composition by dropping the liquid composition from a dosing member arranged above the spaced front faces of the mould parts into the mouth 454 of the reservoir cavity 308. The liquid composition received is held in initial reservoir cavity 308 and fills any mould cavities 305, 405 that are within the initial reservoir cavity.

Mould 20 can then be moved to a partially closed position, as shown in FIGS. 4A and 4B, by moving the mould down the guiding member along the grooves to further engage the side reservoir members 306, 406 and inner faces of the mould parts in a graduated manner from the base reservoir member upwards toward the mouth of the reservoir cavity. In the partially closed position, the side reservoir members and inner mould faces are further engaged to move the reservoir cavity further up mould 20 towards the front faces of the mould parts. This action closes the initial reservoir cavity thereby also closing the filled mould cavities that were arranged within the initial reservoir cavity. The relocated reservoir cavity carries any remaining composition that was not taken up by the initially filled mould cavities. This has the effect of transferring a portion of the liquid ceramic composition higher up the grouping of cavity members to thereby allow for the composition to move from the relocated reservoir cavity 308 into the previously empty open mould cavities that now fall within the relocated reservoir cavity 308. The relocated reservoir cavity is also able to receive additional composition from the dosing member. In a partially closed position, the base of the reservoir cavity is eventually formed by abutment of the inner faces of the mould parts.

The mould parts 300, 400 can then be moved to a closed position in which reservoir members 306, 406, and post-dosing retaining members 310 are fully engaged, thereby closing the reservoir cavity 308 and also closing all of the mould cavities to hold the liquid ceramic composition within the closed mould cavities. Any excess composition is captured in recess 314, 414.

By way of example, a supported catalyst was produced using mould apparatus 30 and a moulding composition formed by mixing the components provided below using the following method.

The alumina powder, pore former and dispersant were mixed to form a powder mixture. An aqueous monomer solution containing the chain forming monomer, the chain linking monomer and the water was added to the powder mixture to form an aqueous slurry. The catalyst and initiator were then added to the aqueous slurry. The amounts of each component in the resulting slurry were:

| | Amount | |
|---|---|---|
| Alumina powder | 475 | |
| Pore former | 60 | g |
| Dispersant | 12.25 | g |
| Polymerisable monomer | 16.3 | g |
| Crosslinking member | 8.2 | |
| Catalyst | 3 | ml |
| Initiator | 8 | ml |
| Water | 135 | g |

The resulting aqueous slurry was then cast into the reservoir cavity of mould 20 from a dosing member arranged above mould 20 while mould 20 was in the open position. Mould 20 was then gradually moved from the open position to partially closed positions with further addition of the aqueous slurry. Mould 20 was then arranged into the closed position. Once the slurry had gelled into a plurality of solid green bodies within the closed enlarged mould cavities the green bodies were then demoulded. At this point the green bodies had a rubbery, jelly-like consistency. The green bodies were then left to dry at room temperature for 24 hours. The dried green bodies were then fired to 1450° C., at which point the binder and pore formers were burnt off to leave solid, porous, packing members.

The packing members were then dipped in an aqueous solution containing catalytic material Ni(NO₃)² before drying at 500° C. This catalytic material impregnation step was repeated two more times to produce supported catalysts.

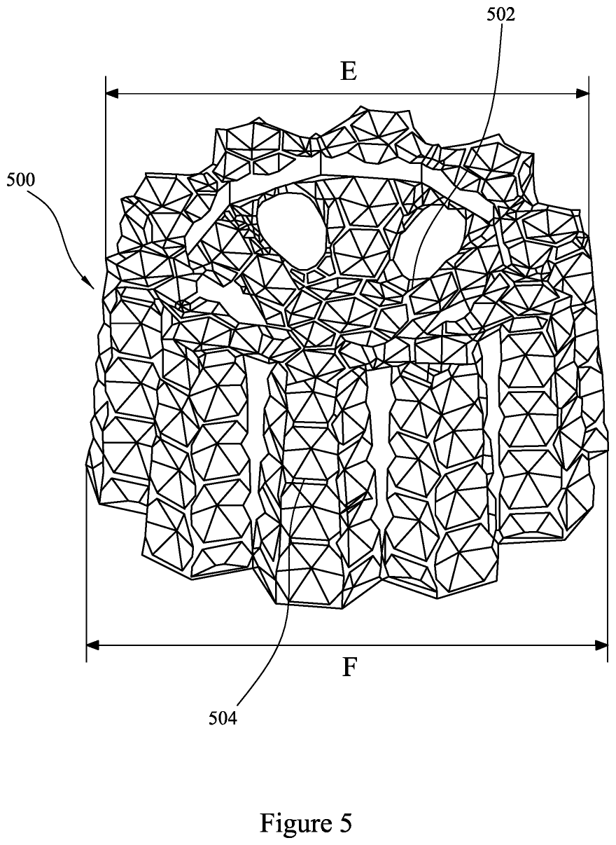

The supported catalysts produced had a macrostructure and surface structure as shown in supported catalyst 500 of FIG. 5. Supported catalyst 500 has macrostructure in the form of a cylindrical cog shape with a plurality of bores (5 in total) extending through the longitudinal length of the support and a plurality of spaced longitudinally orientated castellations (10 in total) that project radially outwards from the support. The macrostructure of supported catalyst 500 further has a depression 502 in the upper face of the support 500. Each of the castellations of the cog are tapered in depth such that the supported catalyst 500 has a largest outer width F at the base (38.0 mm) to a smallest outer width E at the upper face of supported catalyst 500 (35.1 mm). Each castellation is further tapered in width, from a widest point at the base of supported catalyst 500 to a narrowest width at the upper face of supported catalyst 500.

Support catalyst 500 has surface structures extending over substantially the whole outer face of the supported catalyst 500. The surface structures are generally in the form of interconnected hexagon-shaped ridges 502.

In this manner, packing members having improved properties may be manufactured using open vertical filling at the high quantity required in the necessary timespan to achieve a commercially viable production.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A mould for manufacturing a packing member from a liquid ceramic composition, the mould comprising a first part and a second part, wherein the first part and/or the second part comprise an open mould cavity and wherein the first and second parts are operable to engage to form a closed mould cavity, wherein the mould further comprises a reservoir forming member, and wherein the mould is operable to be moved from an open position in which the first and second parts are at least partially spaced such that the reservoir member forms a reservoir cavity and the mould cavity is open, to a partially closed position in which the location of the reservoir cavity has moved with respect to the mould cavity and/or the volume of the reservoir cavity has reduced, and then to a closed position in which the first and second parts are engaged such that the mould cavity is closed.

2. The mould according to claim 1, wherein the first and second parts each comprise an open mould cavity.

3. The mould according to claim 2, wherein the mould cavities of the first and second parts are open partial mould cavities and the first and second parts of the mould are operable to engage such that the partial mould cavity of the first part aligns with the partial mould cavity of the second part to form a closed enlarged mould cavity.

4. The mould according to claim 1, wherein the first and/or the second parts comprise a plurality of open mould cavities.

5. The mould according to claim 1, wherein the mould cavity comprises texturing that is operable to produce surface structures on the packing member.

6. The mould according to claim 1, wherein the reservoir member comprises a first reservoir member arranged on the first mould part and a second reservoir member arranged on the second mould part, wherein the first and second reservoir members are operable to cooperatively engage to form a reservoir cavity.

7. The mould according to claim 6, wherein the first and second reservoir members comprise male and female reservoir members.

8. The mould according to claim 1, wherein the first and/or second mould part comprises side reservoir members extending along opposing sides of the mould cavity of the mould part.

9. The mould according to claim 1, wherein the first and/or second mould part comprises a base reservoir member.

10. The mould according to claim 1, wherein the first and/or second mould part is resiliently deformable.

11. The mould according to claim 1, wherein the material forming the first and/or second mould part has a shrinkage rate of up to 1%.

12. The mould according to claim 1, wherein the mould parts comprise cooperating retaining members operable to assist with maintaining the alignment of the mould parts.

13. The mould according to claim 1, wherein a mould part comprises a reinforcing member.

14. The mould according to claim 13, wherein the reinforcing member protrudes from the mould part to provide a guiding member.

15. A moulding apparatus for use in the production of a packing member from a liquid ceramic composition, the moulding apparatus comprising a mould according to claim 1 and a guiding member operable to arrange the mould in the open position.

16. The moulding apparatus according to claim 15, wherein the guide member is operable to arrange the mould in an open position in which a portion of the mould parts are abutting and a portion of the mould parts are spaced.

17. A process for producing a packing member for use in a packed bed comprising the steps of:
a. arranging a mould comprising a first part and a second part wherein the first part and/or the second part comprise an open mould cavity and wherein the mould further comprises a reservoir forming member, in an open position wherein the first and second parts are at least partially spaced such that the reservoir member forms a reservoir cavity and the mould cavity is open; the mould may be according to claim 1 or be a mould apparatus according to claim 15;
b. at least partially filling the reservoir cavity of the mould with a liquid ceramic composition;
c. moving the mould to a partially closed position such that the location of the reservoir cavity moves with respect to the mould cavity and/or the volume of the reservoir cavity reduces; and
d. moving the mould to a closed position wherein that the first and second parts are engaged to close the mould cavity such that a portion of the liquid ceramic composition is held within the closed mould cavity to produce a green body; and
e. optionally, heating the green body;
f. demoulding the green body; and
g. optionally, calcining the green body to produce a packing member.

18. A packing member for use in a packed bed obtainable by moulding a liquid ceramic composition in a mould according to claim 1.

19. The packing member according to claim 1, wherein the packing member is formed from a cast moulding composition or slip.

20. The packing member according to claim 19, wherein the packing member is formed from a gel-cast composition.

21. (canceled)

22. (canceled)

23. (canceled)

24. (canceled)

25. (canceled)

26. A reactor comprising a catalyst bed wherein the catalyst bed comprises a packing member according to claim 18.
